(19) United States
(12) Patent Application Publication
(10) Pub. No.: US 2009/0180914 A1
(43) Pub. Date: Jul. 16, 2009

(54) Interconnect material and interconnect formation method

(75) Inventors: Motoi Tobita, Kodaira (JP); Yusuke Yasuda, Hitachi (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/292,937

(22) Filed: Dec. 1, 2008

(30) Foreign Application Priority Data
Jan. 10, 2008 (JP) 2008-003544

(51) Int. Cl. B22F 7/00; B32B 15/02

(52) U.S. Cl. 419/5; 428/403

(57) ABSTRACT

A metal particle having an organic substance coated thereon, dispersibility that is the same as that of a known metal particle having an organic substance coated thereon, and an improved low temperature connectability. A method for forming interconnect between materials by using the interconnect materials that include a metal particle on which an organic substance is coated, which includes the steps of coating the interconnect materials on subject interconnect materials, and heating the materials at a temperature in the range of 50 to 400° C. for 1 sec to 10 min to form a sintered body made of metal between the subject interconnect materials. The organic substance is a secondary amine having a molecular weight of 250 or less, and the metal particle is made of a unit of silver, copper, or gold, which has a mean diameter of 100 nm or less, or a mixture thereof.

### CLAIM OF PRIORITY

The present application claims priority from Japanese patent application JP 2008-003544 filed on Jan. 10, 2008, the content of which is hereby incorporated by reference into this application.

### FIELD OF THE INVENTION

The present invention relates to an interconnect material in which a metal particle having a mean diameter of 100 nm or less is used as a base compound, and an interconnect formation method using the interconnect material.

### BACKGROUND OF THE INVENTION

If a diameter of a metal particle is reduced to 100 nm or less and the number of constituent atoms is reduced, it is known that the ratio of atoms exposed to the surface of the particle is rapidly increased, and a melting point and a sintering temperature under a predetermined pressure condition are largely reduced as compared to a bulk state. By using this phenomenon, it is considered that a metal particle with a mean diameter of 100 nm or less is used as a low-temperature interconnect material. For example, JP-A-2004-107728 discloses a method in which by using the interconnect material where the organic substance is coated on the metal particle with a mean diameter of 100 nm or less, the organic substance is decomposed by heating and the metal particles are sintered to achieve interconnection. If this interconnect method is used, the metal particle after the interconnection is converted into the bulk metal and the interconnect interface is interconnected by metal binding. In JP-A-2004-107728, as the organic substance, fatty acid having 5 or more carbon atoms and high alcohol having 8 carbon atoms are used.

Meanwhile, currently, lead-free soldering is required, but there is no material used instead of a Pb-based solder as a solder. In mounting of semiconductor devices, since use of interface solder is necessary, there is a need to develop a material used instead of the Pb-based solder.

In order to manufacture the metal particle with a diameter of 100 nm or less, a method for forming a membrane including an organic substance coated on a metal particle is used. It is required that this membrane prevents coagulation of the metal particles in synthesis and maintains the diameter of the particle at 100 nm or less. Until now, it is known that a metal nanoparticle on which primary alkylamine is coated has the high dispersibility. Meanwhile, in order to increase the low temperature connectability, it is necessary to form the metal interconnection in which the membrane is easily separated and vaporized from the particle by heating the metal particle and the particles have the same interconnect strength as the Pb-based solder. If the interconnection is performed at a low temperature, an interconnect process that has been applied to only a metal substrate is capable of being used in respects to an organic substrate which is weak to heat. In addition, if the interconnection is performed at a low temperature, since thermal expansion of the substrate is reduced, a difference in stress occurring at the interconnect surface may be reduced.

JP-A-2004-273205 discloses a metal particle material on which alkylamine is coated. However, since the material disclosed herein is not for interconnection but lithography, it discloses the high conductivity of the sintered particle but not use of it as the interconnect material and in this case the interconnect strength. In addition, in this patent document, it is preferable to use primary amine as alkylamine for coating metal fine particles in terms of the high binding ability in respects to the surface of the metal.

JP-A-2005-36309 discloses a silver fine particle colloid and a manufacturing method of the same. In this patent document, alkylamine is used as a coating material of the silver fine particle, but, in consideration of the dispersion stability in the organic solvent and coordination to the silver fine particle, it is preferable to use primary amine having long chain as alkylamine.

However, the present inventors found that interconnection that is sufficiently strong to a low temperature of 250° C. or less is not capable of being obtained by using metal nanoparticles on which primary alkylamine is coated.

### SUMMARY OF THE INVENTION

There is provided a metal particle having an organic substance coated thereon, dispersibility that is the same as that of a known metal particle having an organic substance coated thereon, and an improved low-temperature connectability.

The present inventors found that by coating secondary amine having a molecular weight of 250 or less on a metal particle, the dispersibility of the metal particle is maintained, the metal particle having a mean diameter of 100 nm or less is capable of being synthesized, and in respects to the interconnect using the same, interconnection strength that is similar to that of a Pb-based solder is capable of being obtained at lower temperatures as compared to a known interconnection, thereby accomplishing the present invention.

That is, the present invention includes the following characteristics.

(1) A method for forming interconnect between materials by using the interconnect materials that include a metal particle on which an organic substance is coated, the method including the steps of:

coating the interconnect materials on subject interconnect materials; and

heating the materials at a temperature in the range of 50 to 400° C. for 1 sec to 10 min to form a sintered body made of metal between the subject interconnect materials,

in which the organic substance is a secondary amine having a molecular weight of 250 or less, and the metal particle is made of a unit of silver, copper, or gold, which has a mean diameter of 100 nm or less, or an alloy thereof.

(2) The method according to (1), in which a pressure of 10 MPa or less is applied to the subject interconnect material while heating is performed.

(3) The method according to (1), in which the subject interconnect material is metal.

(4) The method according to (1), in which the content of metal in the metal particle on which the organic substance is coated is 80% by mass or more.

(5) The method according to (1), in which the organic substance is secondary alkylamine.

(6) The method according to (1), in which the organic substance is secondary methyl alkylamine.

(7) An interconnect material including:

a metal particle on which an organic substance is coated,

in which the organic substance is secondary amine that has a molecular weight of 250 or less, and the metal particle is made of a unit of silver, copper, or gold, which has a mean diameter of 100 nm or less, or an alloy thereof.

(8) The interconnect material according to (7), in which the interconnect material is used to interconnect metals to each other.

(9) The interconnect material according to (7), in which the interconnect material is used as a solder.

(10) The interconnect material according to (7), in which after the interconnect is formed, the interconnect material is not melted at a temperature of 500° C. or less and has a heat emission property of 50 to 430 W/mK.

(11) The interconnect material according to (7), in which the content of metal in the metal particle on which the organic substance is coated is 80% by mass or more.

(12) The interconnect material according to (7), in which the organic substance is secondary alkylamine.

(13) The interconnect material according to (7), in which the organic substance is secondary methyl alkylamine.

By the present invention, there may be provided a metal particle having an organic substance coated thereon, dispersibility that is the same as that of a known metal particle having an organic substance coated thereon, and an improved low-temperature connectability. In addition, since the metal particle that is made of a unit of silver, copper or gold having a high melting point, or an alloy thereof is used, the heat resistant property may be improved as compared to a known high temperature solder.

### BRIEF DESCRIPTION OF THE DRAWINGS

FIG. 1 is a schematically enlarged view that illustrates an interconnect front cross-section of a structure where a semiconductor device is mounted on a substrate.

### DETAILED DESCRIPTION OF THE PREFERRED EMBODIMENTS

In an embodiment, the present invention relates to a method for forming interconnect between materials by using a metal particle on which an organic substance is coated, which includes the steps of coating the metal particle on which the organic substance is coated on subject interconnect materials, and heating the subject interconnect materials at a temperature in the range of 50 to 400° C. for 1 sec to 10 min to form a sintered body made of metal between the subject interconnect materials. The organic substance is an secondary amine having a molecular weight of 250 or less, and the metal particle is made of a unit of silver, copper, or gold, which has a mean diameter of 100 nm or less, or a mixture thereof (hereinafter, referred to as “interconnect formation method of the present invention”).

As the organic substance used to coat the metal particle, secondary amine is suitable, because of the balance in respects to heat energy provided from the outside in the interconnect formation method according to the present invention. It is required that the heat provided from the outside is used to strip the organic substance in the surface of the metal particle and vaporize it. At a relatively low temperature in the range of 50 to 400° C., preferably 300° C. or less, and more preferably 250° C. or less, in order to strip the organic substance in the surface of the metal particle and vaporize it, it is required that binding energy between the surface of the metal particle and the organic substance and vaporization energy of the organic substance are low. Therefore, the binding energy is calculated by using a calculator simulation based on a quantum mechanic calculation. The used calculation method is a density functional method, BPW91 functional exchange and correlation interaction of electrons are calculated, and a loci is obtained by using a LANL2DZ basis function. The results are described in Table 1.

TABLE 1
Binding energy of the silver side and the organic
molecule based on the calculator simulation

| Organic substance | Classification | Binding energy (kcal/mol) |
|---|---|---|
| Methyl amine | Primary amine | 6.6 |
| Dimethyl amine | Secondary amine | 5.2 |
| Trimethyl amine | Tertiary amine | 2.6 |

From Table 1, it may be seen that the binding energy is reduced in respects to the surface of silver in the order of primary amine, secondary amine, and tertiary amine. That is, it may be seen that secondary amine, and tertiary amine are easily stripped from the metal particle as compared to primary amine that is used in the related art, and are suitable as the organic substance coated on the interconnect metal particle.

Next, the vaporization energy will be described. In general, it is preferable to use a structure where a molecular weight of a functional group bonded to an amino group is small and the content of multibonds is low. As an example of the structure, there is an alkyl group having a molecular weight of 200 or less. In addition, it is preferable that instead of the alkyl group, a group where one or more methylene groups are substituted with —O— in an alkyl ether group that includes an ethyl bondable oxygen atom, that is, in an alkyl group is used. In the case of when the functional group bonded to the amino group is an alkyl group, if the organic substance has the same molecular weight, it may be seen that the vaporization energy is reduced in the order of primary amine, secondary amine, and tertiary amine. In order to largely suppress vaporization energy, the molecular weight of secondary amine needs to be 250 or less, and preferably the molecular weight is preferably 200 or less.

As the secondary amine coated on the metal particle, it is preferable to use secondary alkylamine where at least one of two functional groups belonging to the secondary amine is an alkyl group. As secondary alkylamine, it is more preferable to use secondary alkylalkylamine where two functional groups are an alkyl group, and it is particularly preferable to use secondary methylalkylamin where one of them is a methyl group. In secondary alkylalkylamine, the two alkyl groups are selected so that the molecular weight of amine is 250 or less, and in the two alkyl groups, the sum of the number of carbon atoms is preferably 2 to 16, and more preferably 6 to 10. In the case of when another functional group of secondary alkylamine is not the alkyl group, the corresponding functional group is preferably an alkyl ether group. In the case of when in secondary amine, one functional group is an alkyl group and another functional group is the alkyl ether group, in both functional groups, the sum of the number of carbon and oxygen atoms is 2 to 16 and preferably 6 to 10.

In the present invention, as specific examples of secondary amine coated on the metal particle, there are methyloctylamine, dioctylamine, 1,N-dimethyl-1-heptaneamine, butylpentylamine, dipentylamine, di(3-methylbutyl)amine, 1-methyl, N-ethyl-1-heptaneamine, 1-methyl, N-propyl-1-heptaneamine, dihexylamine, octamyl amine and the like.

Secondary amine coated on the metal particle becomes a component that suppresses the sintering of the metal particle after the interconnection. Accordingly, it is required that remaining sand of the organic substance on the interconnect layer after the interconnection is removed. Thus, it is important to reduce the amount of the organic substance so that the organic substance is decomposed and removed under a condition of a short time and a low temperature interconnection. Therefore, in the present invention, the content of metal in the metal particle on which the organic substance is coated is preferably 80% by mass or more, more preferably 90% by mass or more and 99% by mass or less. By maintaining the content of metal at 80% by mass or more, strong interconnection by metal bonding may be achieved. In the present invention, the content of metal means a value that is measured by using differential thermal analysis and thermogravemetric analysis, and particularly TG-DTA6200 (Seiko Instruments, Co., Ltd.).

In the present invention, the metal particle is made of a unit of gold, silver, or copper, which has a mean diameter of 100 nm or less, or an alloy thereof. Gold, silver, or copper has excellent conductivity, and by maintaining the mean diameter at 100 nm or less and preferably 30 nm or less, the ratio of atom that is exposed to the surface of the particle is rapidly increased and the melting point or the sintering temperature is largely reduced under a predetermined pressure as compared to a bulk state, accordingly, excellent low temperature connectability may be obtained. In addition, the metal particles that are made of a carrier of silver, copper or gold, or an alloy thereof may be used alone or as a mixture thereof.

The metal particle on which the organic substance is coated according to the present invention may be prepared by adding a salt of gold, silver, or copper in a solvent (for example, acid addition salts such as nitrates, sulfates, chlorates and the like) and the organic substance, agitating them, adding a reducing agent thereto, and agitating them. Here, as the solvent, it is preferable to use a polar solvent. As the polar solvent, there are low alcohol such as methanol, ethanol, isopropyl alcohol and the like, acetonitrile, tetrahydrofurane, water and a mixture thereof. To use water, ethanol or a mixture thereof is preferable in terms of ease of waste water treatment. As the reducing agent, for example, there is an ascorbic acid.

The present inventors found that in terms of stability of the interconnect material, the amount of remaining organic substance after the interconnection, and interconnection strength, it is more preferable to use the metal particle that includes a particle having a diameter in the range of 100 nm to 100 μm and a mean diameter 100 nm or less than to use the metal particle that consists of only a particle having a diameter of 100 nm or less. The interconnect material of the present invention includes the metal particle on which the organic substance is coated as a base compound, but may further include a metal particle with diameter in the range of 1 to 100 μm on which the organic substance is not coated or a metal oxide particle.

In order to obtain a metal particle mixture with mean diameter of 100 nm or less that includes a metal particle with diameter of 100 nm or less and a metal particle with diameter of 100 nm to 100 μm, there is a method where after a solvent for making the organic substance coated on the surface of the metal particle is added thereto, the solvent is vaporized to achieve coagulation. In addition, there is a method where heat treatment is performed or UV is irradiated to vaporize the organic substance and achieve the coagulation, but the methods are not limited thereto.

In the interconnect material according to the present invention, scale-like silver and a resin that is made of a thermosetting resin are mixed each other may be used. At this time, as the available thermosetting resin, there are an epoxy resin, a polyimide resin and the like, but the resins are not limited thereto.

The interconnect material of the present invention is a subject interconnect material, and in particular, is appropriately used to form interconnection between metals. The metal as the subject interconnect material is not particularly limited, but, for example, there are a unit of silver, copper or gold, or an alloy thereof. It is preferable that the interconnect material of the present invention includes the organic substance coated on the same metal particle as the metal of the subject interconnect material as a base compound.

In the interconnect formation method of the present invention, after the interconnect material including the metal particle on which the organic substance is coated is coated on the subject interconnect material, by heating the subject interconnect material at a temperature in the range of 50 to 400° C., preferably 300° C. or less, and more preferably 250° C. or less for 1 sec to 10 min and preferably 1 to 5 min, a sintering body of metal between the subject interconnect materials. The interconnect material may be coated on one side or both sides of the subject interconnect materials for interconnection to each other.

In the interconnect formation method of the present invention, it is preferable that the subject interconnect material is pressed under 10 MPa or less and preferably 0.001 to 5 MPa while being heated. By simultaneously heating and pressing the material, the high and strong interconnection may be achieved at a low temperature.

In the case of when the interconnect material of the present invention is used as a paste material, there are a method for spraying a paste from a fine nozzle by an inkjet method to perform coating on an electrode on a substrate or on a connection portion of electronic parts, a method for performing coating by using a metal mask or a mesh-like mask being opened at a required portion thereof, and a method for performing coating on a required portion by using a dispenser. In addition, there are a method for coating a water repellant resin including silicon or fluorine by using a metal mask or a mesh-like mask being opened at a required portion thereof, and a method for coating a water repellent resin having the photosensitivity on a substrate or electronic parts, exposing it, and developing it to remove a portion on which a paste including fine particles is coated and then coat an interconnect paste on the opening. In addition, there is a method for coating a water repellent resin on a substrate or electronic parts, removing a portion on which a paste including metal particle is coated by using a laser, and coating an interconnect paste on the opening. These coating methods may be combined with each other according to an area and a shape of an interconnect electrode. As a paste solvent that is used when the metal particle is pasteurized, phenol, xylene, a terpineol, ethanol and the like may be used.

The interconnection formed by using the interconnect material of the present invention and by the method of the present invention may be applied to interconnection of a semiconductor chip having a high heat emission amount per unit volume that is in size reduction because fusion does not occur at a temperature of 500° C. or less, and a heat emission property is in the range of 50 to 430 W/mK. In addition, it may be applied to interconnection in a high temperature atmosphere around an engine of a vehicle.

### EXAMPLES

### Example 1

The silver particle, on a surface of which methyloctylamine is coated, was manufactured by adding 4.0 g (0.0235 mole) of silver nitrate and 5.1 g of methyloctylamine (0.0356 mole) to 200 mL of the toluene solution, agitating them, mixing them with 3.5 g of the ascorbic acid (0.02 mole), and continuously agitating them for about 1.5 hours. Then, filtration was performed by using a quantitative filter paper (No5C) to remove unreacted silver nitrate and the ascorbic acid. In addition, 200 mL of the acetone solution was added to the toluene solution that was obtained by the filtration and had the silver particle, on the surface of which methyloctylamine was coated, a supernatant solution was removed by precipitating the silver particle, and an excessive amount of methyloctylamine that was not coated on the silver particle and byproducts that were formed in synthesis were removed to perform purification. This process was repeated three times. In addition, by putting the obtained silver particle into the evaporator having the hot-water bath at about 40° C. to vaporize the organic solvent, the dark blue powder was obtained.

### Example 2

The silver particle, on the surface of which dioctylamine was coated, was prepared instead of methyloctylamine by using the same process as Example 1. Silver nitrate and dioctyl amine were mixed with each other at a ratio of 1 mole:1.5 mole.

### Comparative Example 1

The silver particle, on the surface of which oleylamine was coated, was prepared instead of methyloctylamine by using the same process as Example 1. Silver nitrate and oleylamine were mixed with each other at a ratio of 1 mole:1.5 mole.

### Comparative Example 2

The silver particle, on the surface of which laurylamine was coated, was prepared instead of methyloctylamine by using the same process as Example 1. Silver nitrate and laurylamine amine were mixed with each other at a ratio of 1 mole:1.5 mole.

### Comparative Example 3

The silver particle, on the surface of which decylamine was coated, was prepared instead of methyloctylamine by using the same process as Example 1. Silver nitrate and decylamine were mixed with each other at a ratio of 1 mole:1.5 mole.

### Comparative Example 4

The silver particle, on the surface of which octylamine was coated, was prepared instead of methyloctylamine by using the same process as Example 1. Silver nitrate and octylamine were mixed with each other at a ratio of 1 mole:1.5 mole.

### Comparative Example 5

The silver particle, on the surface of which hexylamine was coated, was prepared instead of methyloctylamine by using the same process as Example 1. Silver nitrate and hexylamine were mixed with each other at a ratio of 1 mole:1.5 mole.

### Comparative Example 6

The silver particle, on the surface of which dimethyloctylamine was coated, was prepared instead of methyloctylamine by using the same process as Example 1. Silver nitrate and dimethyloctylamine were mixed with each other at a ratio of 1 mole:1.5 mole.

### Example 3

After the interconnection was performed by using the interconnect material that included the silver particles prepared in Examples 1 and 2 and Comparative Examples 1 to 6, the shear strength test was performed. The used specimen was copper, and the upper one had the diameter of 5 mm and the thickness of 2 mm and the lower one had the diameter of 10 mm and the thickness of 5 mm. After the powder material was coated on the test specimen, the interconnection was performed. The interconnection temperature was 250° C., the interconnection time was 2 min and 30 sec, the pressure was 2.5 MPa, and the low temperature connectability evaluation test was performed. Next, the strength of the interconnection portion was measured under pure shear stress by using the specimen obtained by using the interconnect formation method. In the shear test, the bond tester SS-100K manufactured by SEISHIN TRADING Co., Ltd. (maximum load 100 kg) was used. The shear rate was 30 mm/min, and the specimen was broken by using the shear tool to measure the maximum load when being broken. The maximum load was divided by the interconnect area to obtain the shear strength.

In the present Example, by using the high temperature solder as the index of the shear strength, the ratio of relative strength to shear strength of the interconnect joint that was manufactured at the interconnect temperature of 350° C. for the interconnect time of 5 min while pressure was not applied thereto was obtained. The high melting point solder includes Sn and Pb as main components and is an alloy having a melting point in the range of 280 to 300° C. The obtained ratio of interconnect strength, as shown in Table 2, was 0.46 to 0.27 in Examples 1 and 2, and 0.06 to 0.20 in Comparative Examples 1 to 6.

TABLE 2

| | | Type of | Ratio of |
|---|---|---|---|
| | | organic | interconnection |
| | Organic substance | substance | strength |
| Example 1 | Methyloctylamine | Secondary | 0.46 |
| | | amine | |
| Example 2 | Dioctylamine | Secondary | 0.27 |
| | | amine | |
| Comparative | Oleylamine | Primary | 0.06 |
| Example 1 | | amine | |
| Comparative | Laurylamine | Primary | 0.07 |
| Example 2 | | amine | |
| Comparative | Decylamine | Primary | 0.06 |
| Example 3 | | amine | |
| Comparative | Octylamine | Primary | 0.17 |
| Example 4 | | amine | |
| Comparative | Hexylamine | Primary | 0.20 |
| Example 5 | | amine | |
| Comparative | Dimethyloctylamine | Tertiary | 0.08 |
| Example 6 | | amine | |

### Example 4

The dispersibility was evaluated by using the interconnect material that included the silver particle prepared in Example 1, Comparative Examples 4 and 5. Each powder was weighed and used in an amount of 0.01 g, 1 mL of the toluene solution was added thereto to prepare the dispersion solution. The particle size distribution of the silver particle that was included in the dispersion solution was measured by using MICROTRAC-UPA150 (Honeywell, Co., Ltd.) and a laser Doppler method. The particle size distribution measurement was performed based on volume. The measurement results are described in Table 3. The peak diameters of the interconnect materials of Example 1 and Comparative Example 4 were 7.6 nm, and the particles with the diameter of 9 nm or less were 32% of the whole particles. That is, it may be seen that there is no difference between the dispersibilities of them. Meanwhile, the peak diameter of the interconnect material of Comparative Example 5 were 12.8 nm, and the particles with the diameter of 9 nm or less were 3.6% of the whole particles. It may be seen that the dispersibility was largely lower than those of Example 1 and Comparative Example 4.

TABLE 3

| | Peak | |
|---|---|---|
| | diameter | Ratio of particle with a |
| | (nm) | diameter of 9 nm or less (%) |
| Example 1 | 7.6 | 32 |
| Comparative | 7.6 | 32 |
| Example 4 | | |
| Comparative | 12.8 | 3.6 |
| Example 5 | | |

From the results of Examples 3 and 4, it may be seen that the interconnect material of Comparative Example 4 has the high dispersibility and the low interconnection strength, the interconnect material of Comparative Example 5 has the low dispersibility and the high interconnection strength, and the interconnect material of Example 1 has the high dispersibility and the high interconnection strength.

### Example 5

The content of metal of the interconnect material that included the silver particles prepared in Examples 1 and 2 was measured by using differential thermal analysis and thermogravemetric analysis. For the measurement, TG-DTA6200 (Seiko Instruments, Co., Ltd.) was used. The content of metal was 90% by mass in the interconnect material of Example 1 and 80% by mass in the interconnect material of Example 2.

### Example 6

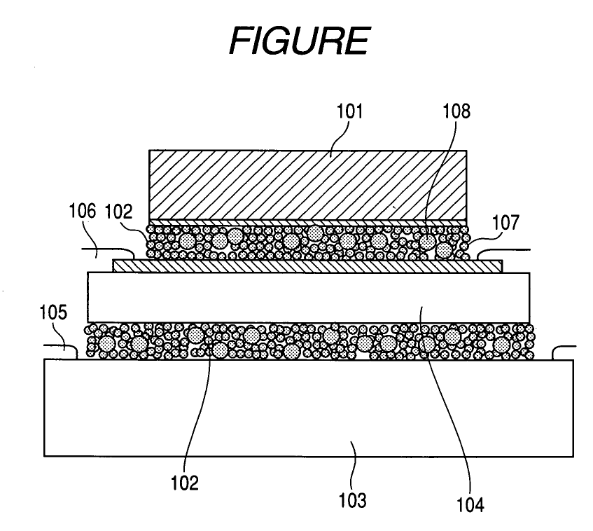

The interconnect material of the present invention may be used when a semiconductor device is interconnected to a substrate. FIG. 1 is a schematically enlarged view that illustrates an interconnect front cross-section of a structure where a semiconductor device 101 is mounted on a substrate. For example, a paste material where the interconnect material of Example 1 was dispersed in the toluene solution in a concentration of 80 wt % may be used as an interconnect material 102. The interconnect material may be a mixture of metal particles with a diameter of 100 nm or more and metal particles with a diameter of 100 nm or less, or include only metal particles with a diameter of 100 nm or less. When the paste material is coated, in order to prevent solution flowing, a water repellent membrane 105 is disposed on the base material 103 corresponding to a mount region of a ceramic insulating substrate 104. In addition, on the ceramic insulating substrate 104, a water repellent membrane 106 is disposed corresponding to a mount region of a semiconductor device 101 to prevent solution flowing when the paste is coated.

What is claimed is:

1. A method for forming interconnect between materials by using the interconnect materials that include a metal particle on which an organic substance is coated, the method comprising the steps of:
coating the interconnect materials on subject interconnect materials; and
heating the materials at a temperature in the range of 50 to 400° C. for 1 sec to 10 min to form a sintered body made of metal between the subject interconnect materials,
wherein the organic substance is an secondary amine having a molecular weight of 250 or less, and
wherein the metal particle is made of a unit of silver, copper, or gold, which has a mean diameter of 100 nm or less, or a mixture thereof.

2. The method according to claim 1, wherein a pressure of 10 MPa or less is applied to the subject interconnect material while heating is performed.

3. The method according to claim 1, wherein the subject interconnect material is metal.

4. The method according to claim 1, wherein the content of metal in the metal particle on which the organic substance is coated is 80% by mass or more.

5. The method according to claim 1, wherein the organic substance is secondary alkylamine.

6. The method according to claim 1, wherein the organic substance is secondary methyl alkylamine.

7. An interconnect material comprising:
a metal particle on which an organic substance is coated,
wherein the organic substance is secondary amine that has a molecular weight of 250 or less, and
wherein the metal particle is made of a unit of silver, copper, or gold, which has a mean diameter of 100 nm or less, or a mixture thereof.

8. The interconnect material according to claim 7, wherein the interconnect material is used to interconnect metals to each other.

9. The interconnect material according to claim 7, wherein the interconnect material is used as a solder.

10. The interconnect material according to claim 7, wherein after the interconnect is formed, the interconnect material is not melted at a temperature of 500° C. or less and has a heat emission property of 50 to 430 W/mK.

11. The interconnect material according to claim 7, wherein the content of metal in the metal particle on which the organic substance is coated is 80% by mass or more.

12. The interconnect material according to claim 7, wherein the organic substance is secondary alkylamine.

13. The interconnect material according to claim 7, wherein the organic substance is secondary methyl alkylamine.
